(19) United States
(12) Patent Application Publication
(10) Pub. No.: US 2006/0227370 A1
(43) Pub. Date: Oct. 12, 2006

(54) Synchronized image transformation processing method for a printer

(76) Inventor: Ching-Wen Wu, Taipei (TW)

Correspondence Address: HARNESS, DICKEY & PIERCE, P.L.C., P.O. BOX 8910, RESTON, VA, 20195, US

(21) Appl. No.: 11/102,824

(22) Filed: Apr. 11, 2005

(51) Int. Cl. G06F 3/12

(52) U.S. Cl. 358/1.15; 358/1.13; 358/1.9

(57) ABSTRACT

A sychronized image transformation processing method for a printer is described for transformation of to-be-printed information into CMYK bitmap information, which may be actually printed by the printer, in which a rendering image process (RIP) device and a color matching and screening (CMS) device are provided for such image transformation. In this method, the RIP and CMS devices are operated synchronously by controlling resource and processing sequence of image segment buffers with software queues, so that a printer engine may rapidly receive the transformed CMYK bitmap information and thus print the to-be-printed information.

### BACKGROUND OF THE INVENTION

1. Field of Invention

The present invention relates to a synchronized image transformation processing technology for a printer, and particularly to a synchronized image transformation processing method for a printer where an RIP (rendering image process) device and a CMS (color matching and screening) device are operated synchronously by controlling resource and processing sequence of image segment buffers with software queues.

2. Related Art

Electronic information is generally printed out as documents by a printer. In printing such electronic information, the to-be-printed information is first transformed into information of a CMYK bitmap format. To this end, a series of software executions are performed, respectively, in a sequential manner in several functional modules in the related art, shown in FIG. 1. At first, the to-be-printed information is transformed into printer definition language (PDL) format document by means of a printer drive. Next, a PDL parsing module 12 is provided to divide the PDL format document into a plurality of RGB image segments, which are subsequently used to generate a RGB bitmap by a RGB transfomation module 14. Then, a color matching module 16 is used to transform the RGB bitmap corresponding to the RGB image segments into a CMYK bitmap corresponding to CMYK image segmentss. Thereafter, a screening module 18 is provided to generate individual C, M, Y and K (halftone) bitmaps from the CMYK image segmentss.

More specifically, the sequentially executed software for transfomation of to-be-printed information into the CMYK bitmap information are described as follows. At first, an application program issues a request for transmitting the to-be-printed information to the printer by the printer driver. Upon the-to-be-printed information being sent, the printer driver transforms each page of the to-be-printed information into a PDL object, each PDL object including various objects such as texts, graphics and raster images, and transformation commands such as ROP, patterns, destinations and sources. At the printer end, an emulator is used to execute the image transformation task. In the emulator, a PDL parsing module 12 is provided to parse the PDL object and transform all the objects of the PDL object into a plurality of RGB image segments, each RGB image segment including 64, 128, 256 or more scan lines 21 as shown in FIG. 2. Subsequently, an RGB rendering module 14 in the emulator generates an RGB bitmap for each of the RGB image segments based on the objects and the commands in the RGB image segment. The RGB bitmap is then stored in an RGB image segment buffer, allocated in the memory of the printer, and has 24-bit information for each pixel therein. Next, a color matching module 16 in the emulator transforms the bitmap of each of the RGB image segments into the CMYK bitmap correponding to the CMYK image segmentss, each pixel in the CMYK bitmap has 8-bit information. Then, a screening module 18 in the emulator generates individual C, M, Y and K (halftone) bitmaps from each of the CMYK image segmentss. Based on resolution provided by the printer engine, the color depth of any of the C. M. Y and K (halftone) bitmaps may be 1 bit, 2 bits or 4 bits. Finally, the C, M, Y and K (halftone) bitmaps are transmitted to the printer engine for the desired printing operation.

Although the image information transformation into CMYK bitmap information is entirely based on software execution, most of the transformation work is performed in a sequential manner, significantly delimiting efficiency of such image information transformation process.

### SUMMARY OF THE INVENTION

To address the problem encountered in the prior art, a color matching module and a screening module in a printer are realized in a hardwared device form, termed herein is a CMS device, so as to speed up the transformation from to-be-printed information into CMYK bitmap information. The CMS device provides a software function and a hardware function, respectively. The software function is performed over the to-be-printed information before being sent to a PDL parsing module and divide the to-be-printed information into a plurality of RGB image segments. On the other hand, the hardware function is performed for the subsequent image transformation and comprises an RIP device and a CMS device.

In this invention, several software queues are provided to control synchronized operations of the RIP device and the CMS device so as to speed up the image transformation process from to-be-printed information to the CMYK bitmap information. More specifically, a plurality of software queues (a first queue, a second queue and a third queue) are used to control the hardware operation sequence of the RIP and CMS devices and resource in the image segment buffers. The image segment buffer comprises a plurality of RGB image segment buffers for storage of the RGB bitmap generated by the RIP device, and a plurality of CMYK image segments buffers for storage of the CMYK bitmap generated by the CMS device. The RIP and CMS devices are operated in a manner described as follows.

When being allowed to access the RGB image segment buffer controlled by the first queue, the RIP device generates the RGB bitmap corresponding to the RGB image segment.

Once the RGB bitmap is generated, the RIP device issues an interrupt signal. At this time, a corresponding interrupt service routine, rip_ISR, is invoked to transmit an image segment identification code to the second queue and enable the DMA channel bridged between the RIP and CMS devices at the same time. As such, the RGB bitmap may be transmitted rapidly to the CMS device. Then, the CMS device generates the CMYK bitmap from the CMYK image segments and releases the image segment identification code of the first queue.

Once the CMYK bitmap is generated, the CMS device issues an interrupt signal. Then, a corresponding interrupt service routine, cms_ISR, transmits an image segment identification code to the third queue and enables the DMA channel, bridged between the CMS device and the printer engine. As such, the CMYK bitmap may be transmitted rapidly to the printer engine and release the image segment identification code of the third queue at the same time.

The implementations of the embodiments according to the present invention will be described in more detail below, with reference to the accompanying drawings.

### BRIEF DESCRIPTION OF THE DRAWINGS

The invention will become more fully understood from the detailed description given hereinbelow illustration only, and thus does not limit the present invention, wherein:

FIG. 1 is a functional block diagram depicting prior software image transformation technology;

FIG. 2 is a schematic diagram showing scan lines;

FIG. 3 is a functional block diagram illustrating hardware image transformation processing technology according to the present invention;

FIG. 4 is a schematic diagram illustrating transfomation of the scan lines into RGB bitmap lines according to the present invention;

FIG. 5 is a schematic diagram illustrating a data flow in the hardware image transformation processing method according to the present invention;

FIG. 6 is a schematic diagram illustrating the data flow in the synchronized image transformation processing method according to the present invention;

FIG. 7 is a flowchart illustrating an emulator operation when the synchronized image transformation processing is performed according to the present invention;

FIG. 8a is a flowchart illustrating an operation of a first interrupt service routine, invoked during the synchronized image transformation processing method, performed according to the present invention;

FIG. 8b is a flowchart illustrating a further detailed operation of the first interrupt service routine, invoked during the synchronized image transformation processing method, performed according to the present invention;

FIG. 9a is a flowchart illustrating an operation of a second interrupt service routine, invoked during the synchronized image transformation processing method, performed according to the present invention; and

FIG. 9b is a flowchart illustrating a further detailed operation of the second interrupt service routine, invoked during the synchronized image transformation processing method, performed according to the present invention.

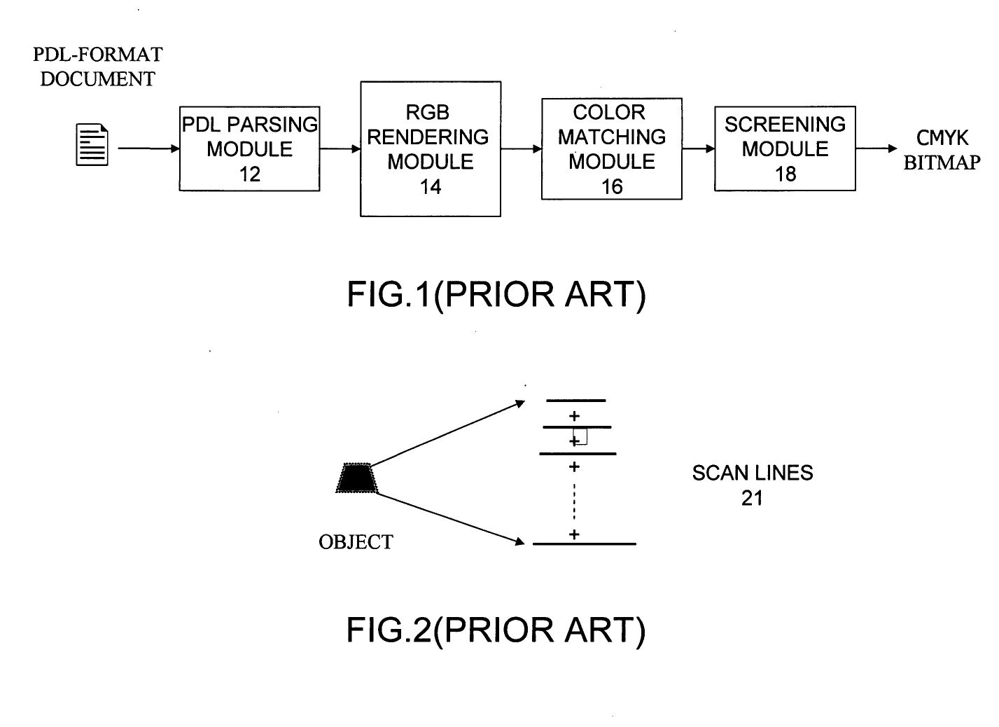

### DETAILED DESCRIPTION OF THE INVENTION

The present invention sets forth a high-speed image transformation processing method used in a printer where an RIP device and a CMS device are combined and software queues are used to control image segment buffers in coorporation therewith, to achieve synchronized image transformation processing. In initializing an image transformation task, an initilization process is invoked to establish an RGB image segment buffer and a CMYK image segments buffer in a memory in the printer. Number and size of the buffers may be allocated based on size of the memory and requirement of the image segments. Further, the temporarily stored information in the buffers is processed in a first-in first-out (FIFO) manner.

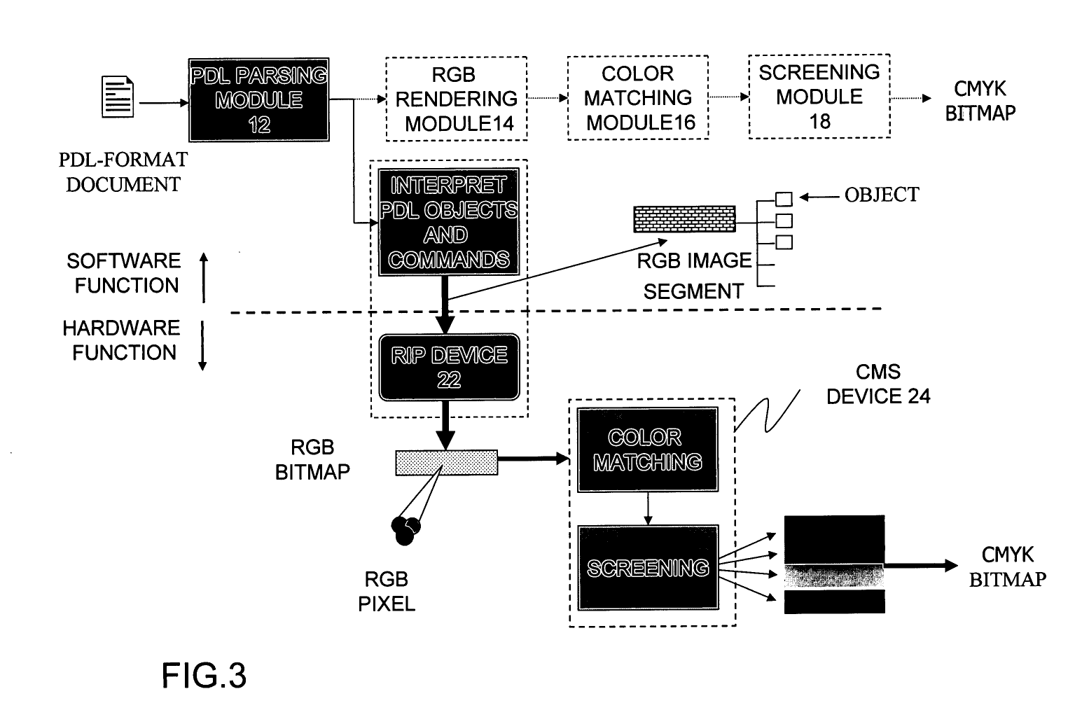

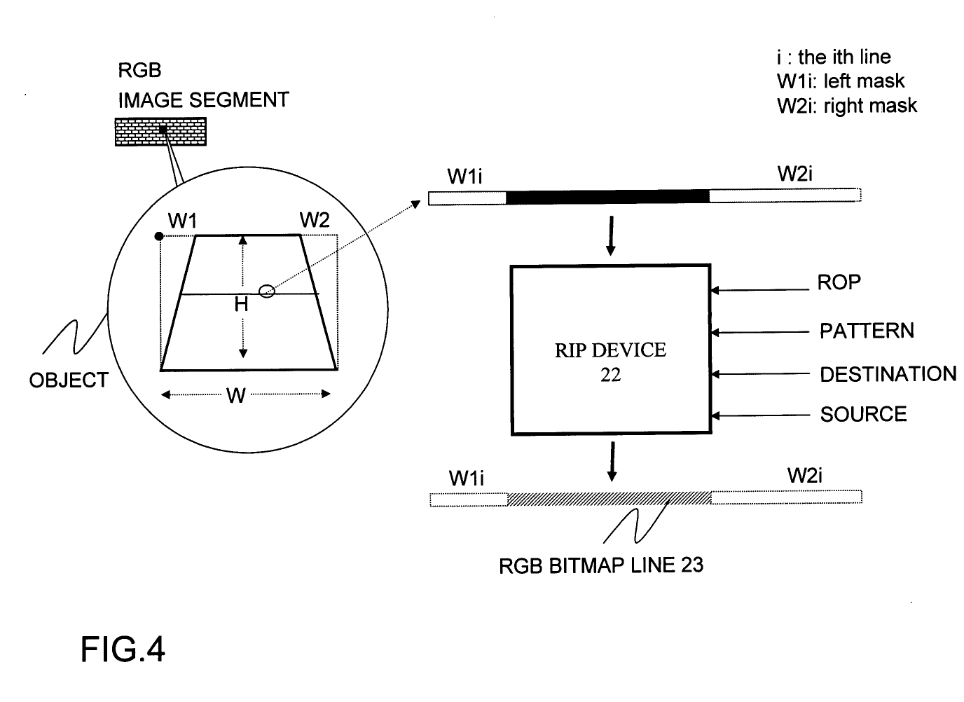

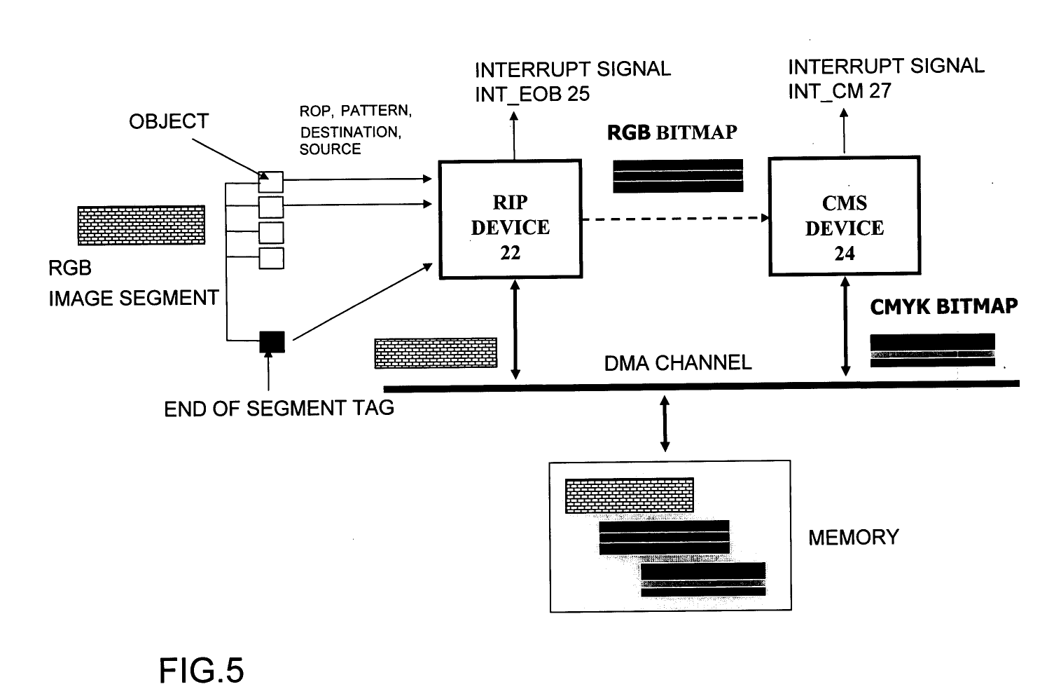

Referring to FIG. 3 through FIG. 5, an emulator is used to provide specifications of RGB bitmap lines and interpret objects and commands in PDL format document. Based on the specifications, objects and commands, the RIP device generates RGB bitmap lines 23, shown in FIG. 4, and stores the RGB bitmap lines into a memory (an image segment buffer) in the printer. According to the present invention, a DMA channel with a cache is provided in the RIP device through which the RGB bitmaps are first stored in the cache and not transferred to the image segment buffer until all scan lines of the objects have been transformed into the RGB bitmap lines or the cache is full. As shown in FIG. 5, when all the objects in the RGB image segment are transformed, the PDL parsing module transmits an end of segment tag to the RIP device. Responsive to the end of segment tag, the RIP device issues an interrupt signal INT_EOB 25 to a central processing unit (CPU). Then, a corresponding interrupt service routine rip_ISR is invoked to inform the CMS device to receive the RGB bitmap and store in the CMYK image segments, corresponding to the RGB image segment through the DMA channel, and generating a CMYK bitmap from the CMYK image segments, the CMYK bitmap including individual C, M, Y and K bitmaps, each having a color depth of 1 bit, 2 bits or 4 bits. The individual C, M, Y and K bitmaps are stored in CMYK image segments buffers, respectively, and may be compressed first and then de-compressed before being transmitted to a printer engine so as to achieve memory saving. When the CMS device generates the CMYK bitmap from the CMYK image segments, the CMS device issues an interrupt signal INT_CM 27 to the CPU. At this time, a corresponding interrupt service routine cms_ISR is invoked to inform the printer engine to receive the C, M, Y and K bitmaps through the DMA channel. As such, the printer engine may print the to-be-printed information based on the CMYK bitmaps.

In this invention, several software queues are provided to control synchronized operations of the RIP device and the CMS device so as to speed up the image transformation process from to-be-printed information to the CMYK bitmap information. More specifically, a plurality of software queues (a first queue, a second queue and a third queue) are used to control the hardware operation sequence of the RIP and CMS devices and resource in the image segment buffers. The image segment buffer comprises a plurality of RGB image segment buffers for storage of the RGB bitmap generated by the RIP device, and a plurality of CMYK image segments buffers for storage of the CMYK bitmap generated by the CMS device. The RIP and CMS devices are operated in a manner described as follows.

When being allowed to access the RGB image segment buffer controlled by the first queue, the RIP device generates the RGB bitmap corresponding to the RGB image segment.

Once the RGB bitmap is generated, the RIP device issues an interrupt signal. At this time, a corresponding interrupt service routine, rip_ISR, is invoked to transmit an image segment identification code to the second queue and enable the DMA channel bridged between the RIP and CMS devices at the same time. As such, the RGB bitmap may be transmitted rapidly to the CMS device. Then, the CMS device generates the CMYK bitmap from the CMYK image segments and releases the image segment identification code of the first queue.

Once the CMYK bitmap is generated, the CMS device issues an interrupt signal. Then, a corresponding interrupt service routine, cms_ISR, transmits an image segment identification code to the third queue and enables the DMA channel, bridged between the CMS device and the printer engine. As such, the CMYK bitmap may be transmitted rapidly to the printer engine and release the image segment identification code of the third queue at the same time.

The image transformation processing method will be discussed more detailed in the context of the description.

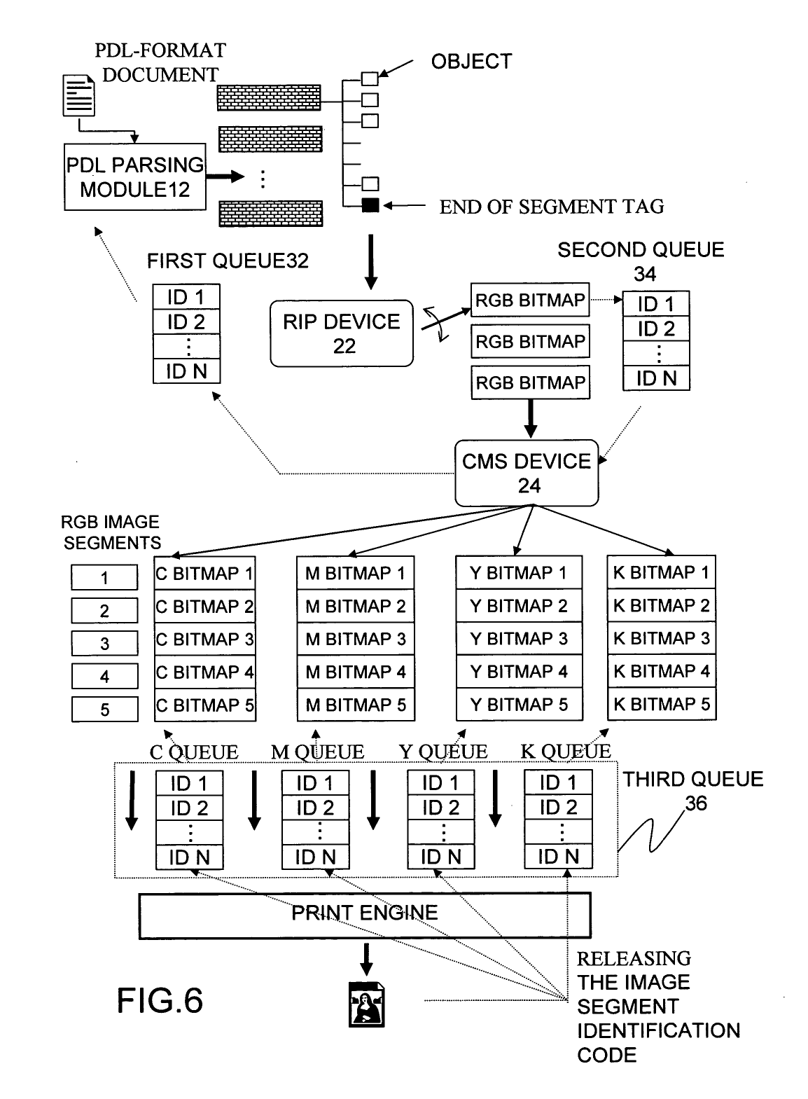

Referring first to FIG. 6, a data flow, illustrating the synchronized image transformation processing method according to the present invention, is provided therein. As shown, an RIP device 22 and a CMS device 24 are main hardwared devices, relied for transfomation of to-be-printed information into desired CMYK bitmap information. Specifically, the RIP device 22 is used to transform an object of an image segment form into an RGB bitmap and store the RGB bitmap into the RGB image segment buffer. On the other hand, the CMS device 24 is used to transform the RGB bitmap corresponding to the RGB image segment into the CMYK bitmap (including individual C, M, Y and K bitmaps) corresponding to the CMYK image segments, and stores the individual C, M, Y and K bitmaps into corresponding C, M, Y and K image segment buffers.

Herein, a plurality of software squeues (a first queue 32, a second queue 34 and a third queue 36) are provided to control operation sequence of the RIP device 22 and the CMS device 24 and resource of the image segment buffers, so as to enable the RIP device 22 and the CMS device 24 to operate synchronously. As such, the transformation of the to-be-printed information into the CMYK bitmap information may be speeded up. The operation of the RIP device 22 and the CMS device 24 during the image transformation processing method of the invention performed is described as follows via the preferred embodiments.

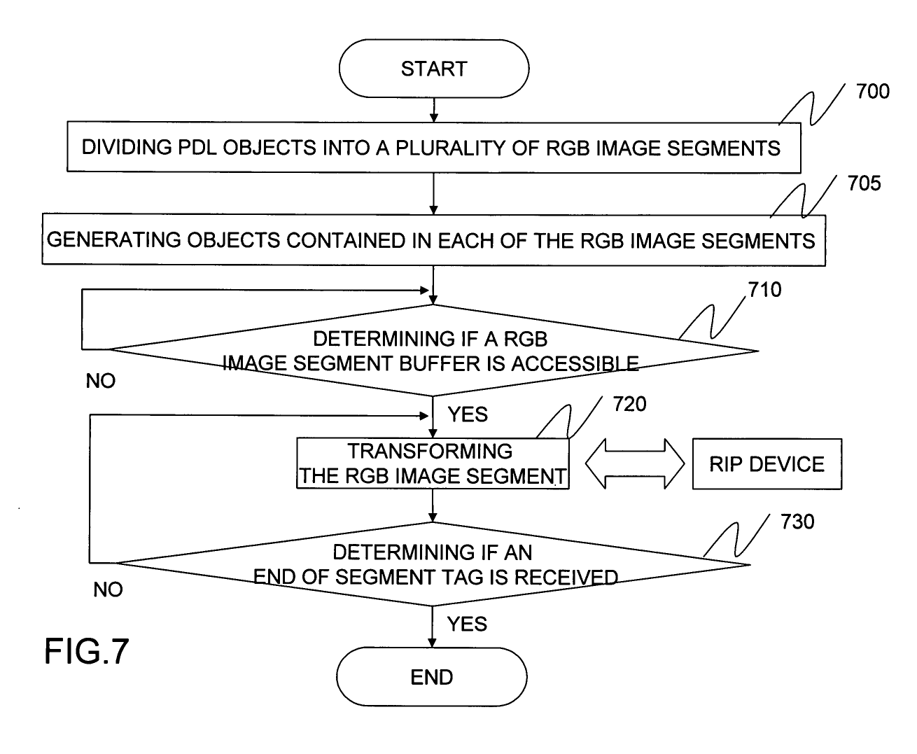

FIG. 7 illustrates an emulator operation when the synchronized image transformation processing method is performed in a printer according to the present invention. As shown, a PDL parsing module in the emulator is used to parse a PDL object and dividing all the objects in the PDL object into a plurality of RGB image segments (Step 700). Then generating objects contained in each of the RGB image segments (Step 705). Next, checking if a RGB image segment (controlled by the first queue) is accessible (Step 710). If not, waiting until the RGB image segment is accessible. If so, transforming the RGB image segment into an RGB bitmap (Step 720). Determining if the accessible RGB image segment is the last RGB image segment (Step 730). If not, transforming the other RGB image segments until the last RGB image segment is transformed.

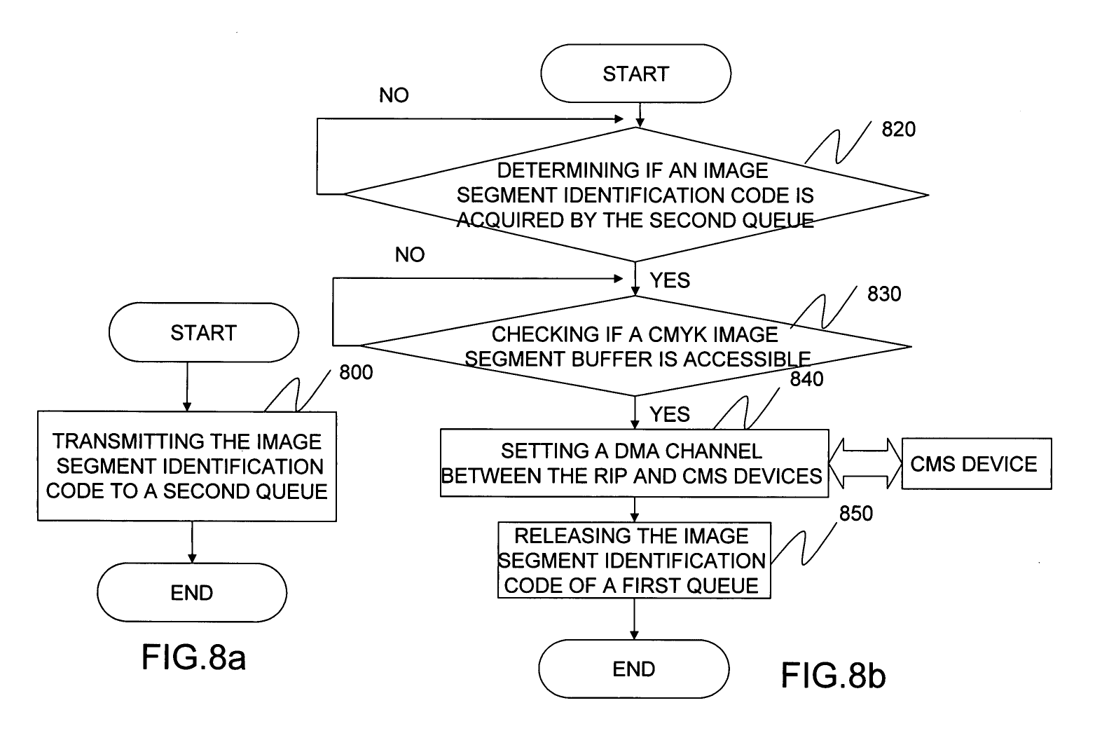

FIG. 8a is a flowchart illustrating an operation of a first interrupt service routine invoked during the synchronized image transformation processing method, performed according to the present invention. As shown, when the RIP device generates the RGB bitmap from the RGB imge segment, the RIP device issues an interrupt signal and a corresponding service routine rip_ISR is invoked to transmit an image segment identification code to the second queue (Step 800).

FIG. 8b is a flowchart illustrating a further detailed operation of the first interrupt service routine invoked during the synchronized image transformation processing method, performed according to the present invention. As shown, concerning the second queue, it is first determined if it has received an image segment identification code (Step 820). If not, wait until the image segment identification code is received. If so, determine if a CMYK image segments buffer is acquired (Step 830). If not, wait until the CMYK image segments buffer is received. If so, set a DMA channel between the RIP device and the CMS device (Step 840), so as to rapidly transmit the RGB bitmap to the CMS device. Further, release the image segment identification code of the first queue (Step 850). As such, the RGB image segment buffer may be re-used by another RGB image segment buffer, wherein the number of the RGB image segment buffers is determined by memory-space in the printer.

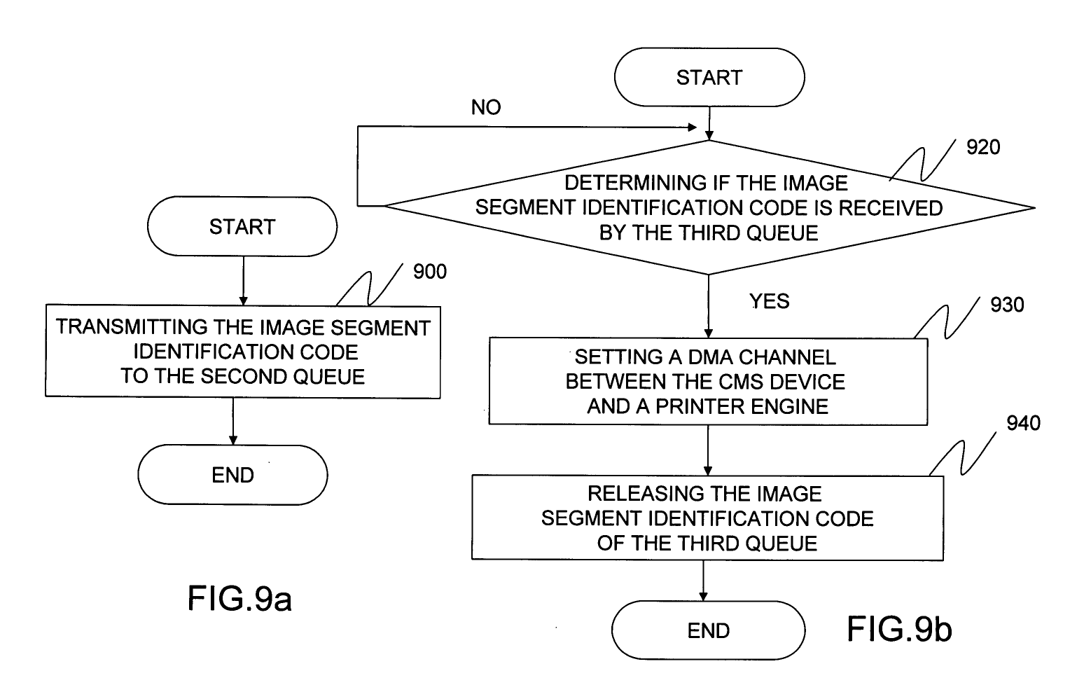

FIG. 9a is a flowchart illustrating an operation of a second interrupt service routine, invoked during the synchronized image transformation processing method, performed according to the present invention. As shown, when the CMS device generates the CMYK bitmap (inclcuding C, M, Y and K bitmaps), the CMS device issues an interrupt signal and a corresponding interrupt service routine (cms_ISR) transmits an image segment buffer to the third queue (inlcuding C, M, Y and K queues corresponding to the C, M, Y andn K bitmaps, respectively) (Step 900).

FIG. 9b is a flowchart illustrating a further detailed operation of the second interrupt service routine, invoked during the synchronized image transformation performed, in which a printer administrator requests the CMYK image segments buffer (including C, M, Y and K image segment buffers) to transmit the CMYK bitmap, corresponding to the CMYK image segments, to the printer engine. As shown, concerning the third queue, it is first determined if it has received an image segment identification code (Step 920). If not, wait until the image segment identification code is received. If, set a DMA channel between the CMS device and the printer engine (Step 930) so as to rapidly transmit the CMYK bitmap corresponding the the CMYK image segments to the CMS device. Then, release the image segment identification code of the third queue (Step 940). As such, the CMYK image segments buffer may be used by another RGB image segment, wherein the number of the CMYK image segments buffers is determined by space of the memory in the printer.

While embodiments and applications of this invention have been shown and described, it would be apparent to those skilled in the art, having the benefit of this disclosure, that many more modifications than mentioned above are possible without departing from the inventive concepts herein. The invention, therefore, is not to be restricted except in the spirit of the appended claims and their equivalents.

1. A synchronized image transformation processing method executed in a printer in which a RIP device and a CMS device operate synchronously to speed up the image transformation by controlling a plurality of RGB image segment buffers and a plurality of CMYK image segments buffers with software queues, comprising the steps of:
executing the RIP device and transmitting an image segment identification code of a first queue among the software queues when the RGB image segment buffer controlled by the first queue is acquired;
receiving the image segment identification code by a second queue among the software queues;
executing the CMS device and transmitting the image segment identification code and releasing the image segment identification code of the first queue;
receiving the image segment identification code by a third queue among the software queues; and
transmitting a CMYK bitmap and releasing the image segment identification code of the third queue;
wherein the RGB image segment buffer of the first queue or the CMYK image segments buffer of the third queue is accessible and reused when the image segment identification code is released.

2. The method of claim 1, wherein the steps of receiving the image segment identification code by a second queue among the software queues and executing the CMS device and transmitting the image segment identification code and releasing the image segment identification code of the first queue further comprises the steps of:
verifying if the second queue has acquired the image segment identification code;
verifying if a CMYK image segments buffer is accessible;
setting a DMA channel between the RIP and CMS device so that a RGB bitmap is transmitted from the RIP device to the CMS device; and
releasing the image segment identification code of the first queue.

3. The method of claim 1, wherein the step of receiving the image segment identification code by a third queue among the software queues and transmitting a CMYK bitmap and releasing the image segment identification code of the third queue further comprises the steps of:
verifying if the third queue has acquired the image segment identification code;
setting a DMA channel between the CMS device and a printer engine in the printer so that a CMYK bitmap is transmitted from the CMS device to the printer engine; and
releasing the image segment identification code of the third queue.

4. The method of claim 1, wherein the RGB image segment buffer is controlled by the first queue and used to store the RGB bitmap generated by the RIP device.

5. The method of claim 1, wherein the CMYK image segments buffer is controlled by the third queue and used to store the CMYK bitmap generated by the CMS device.

6. The method of claim 1, wherein the CMYK bitmap includes a C bitmap, an M bitmap, a Y bitmap and a K bitmap.

7. The method of claim 1, wherein the third queue includes a C queue, an M queue, a Y queue and a K queue.

8. The method of claim 1, wherein the RGB bitmap and CMYK bitmap are stored in the RGB and CMYK image segments buffers respectively in a first-in first-out (FIFO) manner.

9. The method of claim 1, wherein DMA channels having caches are established between the RIP and CMS devices and between the CMS device and printer engine.
